(19) United States
(12) Patent Application Publication
(10) Pub. No.: US 2015/0299525 A1
(43) Pub. Date: Oct. 22, 2015

(54) LOW DENSITY AND HIGH PERFORMANCE PACKAGING HOT MELT

(71) Applicant: IFS INDUSTRIES INC., READING, PA (US)

(72) Inventor: William L. Bunnelle, Ham Lake, MN (US)

(21) Appl. No.: 14/689,899

(22) Filed: Apr. 17, 2015

Related U.S. Application Data
(60) Provisional application No. 61/981,525, filed on Apr. 18, 2014.

(51) Int. Cl. C09J 123/08

(52) U.S. Cl. CPC C09J 123/0815; C09J 2423/04

(57) ABSTRACT

Disclosed are hot melt adhesives combining an ethylene/a-olefin copolymer, an isotactic polypropylene polymer or copolymer, a nucleating agent and a tackifing resin that can be used in case or carton applications.

### CROSS REFERENCE TO RELATED APPLICATIONS

This application claims the benefit of provisional application Ser. No. 61/981,525, filed Apr. 18, 2014, which application is incorporated herein by reference.

### FIELD

The claimed materials relate to hot-melt adhesive compositions that can be used in a variety of adhesive applications. The claimed adhesives can be blended and optimized for case and carton-sealing applications with reduced add-on weights while retaining superior high temperature and low temperature properties even in difficult to bond surfaces case and carton materials.

### BACKGROUND

Hot-melt adhesives have been formulated from polymeric compositions for many years. Hot-melt adhesives are typically applied to substrate at elevated temperatures for the purpose of forming an adhesive bond. In many applications, the molten adhesive is applied as a typically geometrical or oval or circular cross-sectional bead to a substrate. While still molten, a second substrate is typically contacted with the molten adhesive thus forming an adhesive bond. The resulting bond must retain sufficient adhesive character to be mechanically stable, but also the adhesive must retain cohesive characteristics such that the bond does not fail in the adhesive mass. Often hard to bond substrates require special formulation materials.

The economics of the use of such adhesive materials depends largely on the cost of the materials, and on the density of the resulting blended hot-melt adhesive. If typical adhesive compositions are used wherein the density is greater than about 0.90 grams per cubic centimeter or even greater than 0.99 grams per cubic centimeter, an extruded bead with a diameter of about 1 to 4 or 1.5 to 3.5 millimeters (about one sixteenth to one eighth inches) both contain a relatively large amount of adhesive with an associated cost. If an adhesive material can be produced at lower density, less than 0.90 grams per cubic centimeter, a similar bead will have less material and less associated costs.

A substantial need exists to obtain a quality hot melt adhesive that combines adhesive and cohesive properties at a range of temperatures and substrate characteristics with reduced density (less than 0.90 grams per cubic centimeter). Typical commercial hot melts are typically 0.95 to 1.03 g-cm⁻³.

### BRIEF DISCUSSION

We have found an adhesive that can include a metallocene catalyzed/ethylene alpha-olefin polymer, a crystalline isotactic polypropylene polymer or copolymer, optionally can include at least one nucleating agent such as a polyolefin wax for faster set times, and typically less than about 10 weight percent of a tackifing resin. We have found that the crystallinity resulting from the isotactic polypropylene in combination with the nucleating agent can provide rapid bond-setting properties while a combination of metallocene polymer and tackifier can produce excellent initial green-strength bonding and final adhesive and cohesive bond strength. An aspect of the claimed materials is a nucleating agent composed of a polyethylene wax having a density of greater than 0.95 g-cm⁻³. Another aspect of the claimed adhesive is an article of manufacture including a hot melt adhesive composition of the claimed adhesive. Another aspect of the claimed adhesive is a method of making an article of manufacture by applying a hot melt adhesive composition of the claimed adhesive to a first substrate and rapidly joining the first substrate to a second substrate to form an adhesive bond that is of sufficient strength for the intended end use.

We have found that when properly formulated, the adhesives can have a density that is less than 0.90 g-cm⁻³, less than 0.88 g-cm⁻³, less than 0.86 g-cm⁻³ and often less than 0.85 g-cm⁻³. As a result, a reduced amount of adhesive can be applied to a substrate or work piece while still maintaining excellent adhesive and cohesive properties in the bond. The hot-melt adhesive is made from materials of reduced cost, but also when formulated into a final hot-melt composition has a minimal density resulting in reduced adhesive add-on while maintaining excellent cohesion and adhesion in the adhesive bond and excellent deboning resistance at high temperatures while retaining low temperature performance.

Additional advantages and novel features of the claimed adhesive will be set forth in part in the description that follows, and in part will become apparent to those skilled in the art upon examination of the following, or may be learned through routine experimentation upon practice of the claimed adhesive.

### DEFINITIONS

As used herein, the term “nucleating agent” means a compound or class of compounds that decrease the effective set time of a hot melt composition.

As used herein, the term “crystalline content” means a compound or a portion of a compound that is capable of forming crystalline structure.

As used herein, the term “effective set time” means the amount of time elapsed between application of a molten hot melt adhesive composition to a first substrate, and formation of an adhesive bond between the first substrate and a second substrate that is of sufficient strength for an intended end use.

As used herein, the term “open time” means the amount of time elapsed between application of a molten hot melt adhesive composition to a first substrate, and the time when wetting out of the adhesive on a substrate effectively ceases due to solidification of the adhesive composition. Open time is also referred to as “working time.”

As used herein, the term “substrate” means any item having at least a partially solid surface with which contact with a hot melt adhesive composition is intended. In some cases the same area, bead, line, or dot of hot melt adhesive composition is contacted to two or more substrates for the purpose of creating an adhesive bond between them. In some such cases the substrates are part of the same item: for example, two sides of a cardboard sheet folded over, wherein the two sides are adhesively bonded together. In other such cases the substrates are part of different items: for example, a plastic film that is adhesively bonded to a cardboard sheet. The substrates are porous or nonporous.

As used herein, the term “substantially” means the same or uniform but allowing for or having minor fluctuations from a defined property, definition, etc. For example, small measureable or unmeasurable fluctuations in a measured property described herein, such as viscosity, melting point, etc. may result from human error. Other fluctuations are caused by variations in the manufacturing process, thermal history of a formulation, and the like. The adhesive compositions of the claimed adhesive, nonetheless, would be said to be substantially having the property as reported.

For the purpose of this disclosure, unless otherwise specified, density in grams per cubic centimeter of the polymer or polymer-blender composition is either calculated from its components or measured according to ASTM D-792. Melt index or MI is measured according to ASTM D-1238.

### BRIEF DISCUSSION OF FIGURES

FIGS. 1-2 show the increased performance and density of the claimed adhesive materials.

### DETAILED DESCRIPTION

The hot melt adhesives comprise at least two different olefin polymers and are typically an ethylene alpha olefin polymer and a crystalline isotactic polypropylene. The term “different” is used herein to mean that the polymers differ with respect to, for example, monomer content, Melt Index, melting point, crystallinity or molecular weight.

The term “ethylene/α-olefin polymer” generally refers to polymers comprising ethylene and an α-olefin having 3 or more carbon atoms. Ethylene comprises the majority mole fraction of the whole polymer, i.e., ethylene comprises at least about 50 mole percent of the whole polymer. Ethylene comprises at least about 60 mole percent, at least about 70 mole percent, or at least about 80 mole percent, with the substantial remainder of the whole polymer comprising at least one other comonomer that is an α-olefin having 3 or more carbon atoms. Ethylene/octene copolymer, the comprises an ethylene content greater than about 80 mole percent of the whole polymer and an octene content of from about 10 to about 15, or from about 15 to about 20 mole percent of the whole polymer.

Polyolefin ethylene/L-olefin polymer copolymers that can be used in the practice of the claimed adhesive include AFFINITY® polyolefin elastomers available from Dow Chemical. Suitable ethylene/octene polymers have a Tg about −25° C., −50° C. or −70° C. The polymer is used in the adhesive at about 30% to 70% by weight and in other embodiments at 45% to 55% by weight.

Isotactic generally crystalline polypropylene can be used in the adhesive. Generally, such isotactic polymers have molecular weight of up to about 50.000. The molecular weight of isotactic polypropylene found particularly suitable for the composition of the claimed adhesive is 1,000 to 20,000. The polymer comprises random units of propene or propylene can be a homopolymer and can also optionally have about 5 to 50 wt. % of a different (non-propene) α-olefin having the formula:

A-CH═CH₂

wherein A is hydrogen or a C₂₋₁₀ alkyl group, often ethylene. The polymer is used in the adhesive at about 45% to 55% by weight, in other embodiments at 40% to 50% by weight, and lastly at about 35% to 45% by weight.

In these formulations the ethylene/α-olefin polymer provides flexibility and low temperature properties while the isotactic polypropylene wax provides speed of set high temperature properties without the reduction in adhesive common form typical petroleum, microcrystalline or FT wax. In embodiments, the propylene copolymers are polymerized using a metallocene catalyst and associated polymerization techniques. Metallocene catalysts are well known in the patent and non-patent literature and have been used to form propylene polymers having varying but reproducible stereoregular content. Suitable catalysts include bis-metallocene complexes having cyclopentadienyl ligands capable of producing polymerized propylene sequences that are either isotactic or syndiotactic. A list of some metallocene ligands, as well as co-catalysts useful in conjunction with the metallocene catalysts in the syntheses of stereoregular propylene polymers, is found in U.S. Pat. No. 6,747,114. Some transition metal compound components are described in U.S. Pat. Nos. 5,145,819; 5,243,001; 5,239,022; 5,329,033; 5,296,434; 5,276,208; 5,672,668, 5,304,614 and 5,374,752; and in European Patent Publication Nos. EP549900 and EP576970. Further, any of the techniques described in these documents, as well as others widely found in the art, can be employed to make propylene copolymers that are useful in the hot melt adhesive compositions of the claimed adhesive.

In embodiments, the propylene copolymer is a copolymer of propylene and ethylene. In other embodiments, the propylene copolymer is a copolymer of propylene and an α-olefin (linear 1-alkene). In some such embodiments the α-olefin is 1-butene. In other embodiments the α-olefin is 1-hexene. In still other embodiments, the propylene copolymer includes propylene, ethylene, and an α-olefin. In embodiments, the average propylene content of the propylene copolymer is about 80 mol % to 99.9 mol %, in some embodiments about 90 mol % to 99 mol %. In embodiments, the propylene copolymer is semicrystalline when in a solid state. In embodiments some repeat unit sequences in the propylene copolymer are isotactic; in other embodiments some repeat unit sequences in the propylene copolymer are syndiotactic. In embodiments, crystalline content in the propylene copolymer is derived from isotactic or syndiotactic block-like sequences. Crystalline isotactic polypropylene can be a homopolymer or has about 50 to 95 mol % propylene and 5 to 50 mol % ethylene.

The propylene polymers useful in the hot melt adhesive compositions of the claimed adhesive have a Brookfield viscosity measured at 190° C. according to ASTM D3236 (spindle #27, 5 RPM on a Brookfield viscometer) of about 200 cP to 25,000 cP, in embodiments about 400 cP to 10,000 cP, in embodiments about 600 cP to 5000 cP, and in embodiments about 700 cP to 2000 cP. The propylene copolymers useful in the hot melt adhesive compositions of the claimed adhesive have a density in solid form of about 0.87 g/cm⁻³ to 0.9 g/cm⁻³. The propylene copolymers useful in the hot melt adhesive compositions of the claimed adhesive have a peak melting temperature of about 131° C. to 170° C.

The adhesive can contain a nucleating agent. Several examples of useful nucleating agents will now be described. Where reported, density of the nucleating agent is measured either at 23° C. or 25° C. One example of a nucleating agent useful in the adhesive compositions of the claimed adhesive is LICOCENE® PE 4201, available from Clariant International Ltd. LICOCENE® PE 4201 is a metallocene catalyzed polyethylene wax having a density of 0.97 g/cm⁻³, a viscosity of 40 cP to 80 cP at 140° C., and a Mettler drop point of 125° C. to 130° C. according to ASTM D3954. Another example of a nucleating agent useful in the adhesive compositions of the claimed adhesive is LICOCENE® PE 5301, available from Clariant International Ltd. LICOCENE® PE 5301 is a metallocene catalyzed polyethylene wax and has a density of 0.97 g/cm⁻³, a viscosity of about 350 cP at 140° C., and a drop point of 128° C. to 133° C. according to ASTM D3954. Another example of a nucleating agent useful in the adhesive compositions of the claimed adhesive is POLYWAX™ 3000 polyethylene homopolymer, available from Baker Hughes Incorporated of Sugar Land, Tex. POLYWAX™ 3000 has a density of 0.98 g/cm⁻³, a viscosity of 130 cP at 149° C. according to a modified ASTM D88 procedure, and a melting point of 129° C. according to ASTM D127. Another example of a nucleating agent useful in the adhesive compositions of the claimed adhesive is POLYWAX™2000 polyethylene homopolymer, available from Baker Hughes Incorporated. POLYWAX™2000 has a density of 0.97 cm⁻³, a viscosity of 50 cP at 149° C. according to a modified ASTM D88 procedure, and a melting point of 126° C. according to ASTM D127. Another example of a nucleating agent useful in the adhesive compositions of the claimed adhesive is POLYWAX™1000 polyethylene homopolymer, available from Baker Hughes Incorporated. POLYWAX™1000 has a density of 0.96 cm⁻³, a viscosity of 15 cP at 149° C. according to a modified ASTM D88 procedure, and a melting point of 113° C. according to ASTM D127. Another example of a nucleating agent useful in the adhesive compositions of the claimed adhesive is POLYWAX™850 polyethylene homopolymer, available from Baker Hughes Incorporated. POLYWAX™ 850 has a density of 0.96 cm⁻³, a viscosity of 13 cP at 149° C. according to a modified ASTM D88 procedure, and a melting point of 107° C. according to ASTM D127. Another example of a nucleating agent useful in the adhesive compositions of the claimed adhesive is Honeywell A-C® 820A polyethylene homopolymer, available from Honeywell International Inc. A-C® 820A has a density of 0.97 g/cm⁻³, a Brookfield viscosity of 50 cP to 150 cP at 140° C., and a Mettler drop point of 123° C. to 133° C. Nucleating agents are used at less than 10 wt %, in other embodiments less than 5 wt % and often less than 3 wt %.

Tackifing resins useful in the adhesive compositions of this claimed adhesive include hydrocarbon resins, synthetic polyterpenes, rosin esters, natural terpenes, and the like. The tackifing agent will generally be present at a level of from about 5 to about 20% by weight of the adhesive composition and at a level of less than about 10% by weight.

More particularly, and depending upon the particular base polymer, the useful tackifing resins may include any compatible resins or mixtures thereof such as natural and modified rosins including, for example, as gum rosin, wood rosin, tall oil rosin, distilled rosin, hydrogenated rosin, dimerized rosin, and polymerized rosin; glycerol and pentaerythritol esters of natural and modified rosins, including, for example as the glycerol ester of pale, wood rosin, the glycerol ester of hydrogenated rosin, the glycerol ester of polymerized rosin, the pentaerythritol ester of hydrogenated rosin, and the phenolic-modified pentaerythritol ester of rosin; copolymers and terpolymers of natured terpenes, including, for example, styrene/terpene and alpha methyl styrene/terpene; polyterpene resins having a softening point, as determined by ASTM method E28-58T, of from about 80° C. to 150° C.; phenolic modified terpene resins and hydrogenated derivatives thereof including, for example, the resin product resulting from the condensation, in an acidic medium, of a bicyclic terpene and a phenol; aliphatic petroleum hydrocarbon resins having a Ball and Ring softening point of from about 70° C. to 135° C.; aromatic petroleum hydrocarbon resins and the hydrogenated derivatives thereof; and alicyclic petroleum hydrocarbon resins and the hydrogenated derivatives thereof. Mixtures of two or more of the above described tackifing resins may be required for some formulations. Also included are the cyclic or acyclic C₅ resins and aromatic modified acyclic or cyclic resins.

Tackifiers are synthetic hydrocarbon resins derived from petroleum. Non-limiting examples include aliphatic olefin derived resins such as those available from Goodyear under the Wingtack® and the Escorez® 1300 series from Exxon. A common C₅ tackifing resin in this class is a diene-olefin copolymer of piperylene and 2-methyl-2-butene having a softening point of about 95° C. This resin is available commercially under the Wingtack 95 and is prepared by the cationic polymerization of a mixture containing approximately 60% piperylene, 10% isoprene, 5% cyclopentadiene, 15% 2-methyl-2-butene and about 10% dimer, as taught in U.S. Pat. No. 3,577,398. The resins normally have ring and ball softening points as determined by ASTM method E28 between about 20° C. and 150° C. Also useful are C₉ aromatic/aliphatic olefin-derived resins available from Exxon in the Escorez 2000 series. Hydrogenated hydrocarbon resins are especially useful. These hydrogenated resins include such resins as the Escorez 5000 series of hydrogenated cycloaliphatic resins from Exxon, hydrogenated C₉ and/or C₅ resins such as Arkon® P70, P90, P115, P125 supplied by Arakawa Chemical, hydrogenated aromatic hydrocarbon resins such as Regalrez® 1018, 1085 and the Regalite® R series of resins from Hercules Specialty Chemicals. Other useful resins include hydrogenated polyterpenes such as Clearon® P-105, P-115 and P-125 from the Yasuhara Yushi Kogyo Company of Japan. Mixtures of such tackifying agents may also be used. Packifiers are terpene and phenol resins.

Styrenated terpene resins are co-polymers of a terpene—obtained from pine trees (via sulfate turpentine, a by-product of the Kraft paper manufacturing process or gum turpentine, which is obtained from living pine trees). The useful terpenes for synthesizing such co-polymers, obtained from pine trees have the general formula C₁₀H₁₆. Typical examples are alpha pinene, beta pinene. Dipentene, and delta-3-carene or d-limonene (also C₁₀H₁₆). The styrene-terpene copolymers useful for adhesive applications are predominantly obtained via cationic polymerization of the terpene (or a blend of terpenes) and styrene, using Lewis acid catalystin a hydrocarbon solvent. The typical styrenated terpene resins are solids at ambient temperature and the most useful tackifier resins used in hot melt packaging, non-woven and hot melt pressure sensitive adhesives are those with a softening point (SP) of from about 95 to about 115° C., a weight average molecular weight (Mw) of less than about 2000, a number average molecular weight (Mn) of less than about 1000, and a polydispersity of less than about 2.0. Although styrenated terpene resins can be synthesized using any of the aforementioned terpenes, historically it has been d-limonene or even dipentene (racemic limonene) that has been found to have the most favorable impact on overall reactivity and ease of polymerization of the terpene-styrene system under cationic polymerization conditions. The following commercial styrenated terpene resins are available from Arizona Chemical Company: Silvares® 2040.

The adhesive can include about less than 10% by weight, less than 9% by weight, and can be less than 8% by weight, of tackifier. Optional components such as filler, colorant, blowing agent, fluorescing agent, surfactant and the like can be added to the basic composition to further modify its properties, as desired.

The hot-melt adhesives of the claimed adhesive find use in, for example, case and carton sealing, packaging, book binding, and adhering nonwoven materials. The adhesives can be used in adhering or forming cases, cartons, trays, heat-sealing applications, in the packaging of foods including cracker materials, breakfast cereals, beverages including beer and other products.

The adhesives are typically used by extruding a typically oval or circular cross-section bead onto a substrate using a pressure-driven pump or gear-pump equipment. Nordson, ITW and other companies provide useful hot-melt application equipment. Typically the adhesives are formed into masses having a size appropriate for application to the equipment in which they can be readily melted and then extruded. The adhesive beads extruded by such equipment typically have a circular cross-section with a diameter of about 1 to 4 or 1.5 to 3.5 millimeters.

Additional components employed in some embodiments of the hot melt adhesive compositions of the claimed adhesive include antioxidants and free radical scavengers. These materials are commonly employed in hot melt adhesive formulations in order to increase thermal stability of thereof. This is because during use the compositions are often held at high temperatures for extended periods of time, for example in a holding tank or cartridge. Generally, hot melt adhesive formulations are heated to between about 110° C. and 200° C., in some embodiments between about 130° C. and 170° C., in still other embodiments between about 150° and 175° C., prior to application in order to reduce viscosity of the composition. The formulations must be stable at these temperatures to allow for extended periods as a molten product prior to application. In embodiments, antioxidants such as hindered phenols are employed in the hot melt adhesive compositions of the claimed adhesive. Representative hindered phenols include 1,3,5-trimethyl-2,4,6-tris(3-5-di-tert-butyl-4-hydroxybenzyl)benzene; pentaerythritol tetrakis-3(3,5-di-tert-butyl-4-hydroxyphenyl)propionate; n-octadecyl-3(3,5-ditert-butyl-4-hydroxyphenyl) propionate; 4,4′-methylenebis(4-methyl-6-tert butylphenol); 4,4′-thiobis(6-tert-butyl-o-cresol); 2,6-di-tert-butylphenol; 6-(4-hydroxyphenoxy)-2,4-bis(n-ocytlthio)-1,3,5-triazine; 2,4,6-tris(4-hydroxy-3,5-di-tert-butyl-phenoxy)-1,3,5-triazine; di-n-octadecyl-3,5-di-tert-butyl-4-hydroxybenzylphosphonate; 2-(n-octylthio)ethyl-3,5-di-tert-butyl-4-hydroxybenzoate; and sorbitol hexa-(3,3,5-di-tert-butyl-4-hydroxy-phenyl) propionate. One example of a useful hindered phenol is IRGANOX® 1010 (pentaerythritol tetrakis(3-(3,5-di-tert-butyl-4-hydroxyphenyl)propionate), available from BASF Corp. of Florham Park, N.J.), and free radical scavengers such as, but not limited to, butylated hydroxytoluene or “BHT”, and butylated hydroxyanisole or “BHA”, available from multiple vendors. Any of these materials are advantageously added to the hot melt adhesive compositions of the claimed adhesive to further enhance thermal stability. These free radical scavengers and antioxidants are generally added to the hot melt adhesive compositions of the claimed adhesive in amounts ranging from about 0.01% to 5% by weight of the composition. In some embodiments stabilizers and antioxidants are employed in the fugitive adhesive compositions of the claimed adhesive in amounts ranging from about 0.1% to 1.5% by weight of the composition. Since the free radical scavengers and antioxidants are optional components of the hot melt adhesive composition of the claimed adhesive, any of the recited ranges include 0 wt % to any of the recited amounts in various embodiments, for example 0 wt % to 0.01 wt %, 0 wt % to 5 wt %, and so forth.

The hot melt adhesive compositions of the claimed adhesive are formed using conventional techniques. Procedures and methods for formulating hot melt adhesive compositions are well known in the art. Any of these procedures may be used to blend and prepare the hot melt adhesive compositions of the claimed adhesive. The method of blending and preparing the hot melt adhesive compositions of the claimed adhesive is not particularly limited. Descriptions of those procedures and methods are reviewed, for example, in Skeist, Irving, Handbook of Adhesives, Van Nostrand Reinhold International; 3rd edition (1990).

Articles of the claimed adhesive include items having any two or more substrates adhesively bonded by a hot melt adhesive composition of the claimed adhesive. Articles of the claimed adhesive include cartons, boxes, envelopes, comestibles containers, books, magazines, disposable articles such as diapers or feminine napkins, and the like. The substrates that are adhesively bonded in such articles are formed from materials such as cardboard, paper, wood, aluminum, tin, steel, thermoplastics such as polyesters such as polyethylene terephthalate, polyamides such as nylons, or polypropylene, thermoset polymers, glass, ceramics, and combinations, blends, or layered composites thereof and include, in some embodiments, coatings of wax, acrylate polymers, or other materials; colorants, preservatives, stabilizers, processing lubricants, and the like as well as combinations of any of these materials. The substrates include solid, nonporous items and sheets as well as porous items and sheets, such as nonwoven fabrics, paper, cotton batting, and the like.

In industrial applications, the outstanding thermal stability, widened operating service temperature window exceeding known adhesives (up to as high as 275° F., 135° C.) combined bonding a low temperature bonding properties with rapid effective set time of the hot melt adhesive compositions of the claimed adhesive provide a broader scope of utility than are realized with conventional hot melt adhesives, and in particular those hot melt adhesives based on metallocene polymerized propylene copolymers known in the art. Productivity in terms of throughput on a conveyor belt system, for example, is greatly increased by the rapid effective set time provided by the hot melt adhesive compositions of the claimed adhesive. For example, some industrial packaging applications currently do not employ hot melt adhesives because the effective set time is several seconds, such as between 5 and 15 seconds or longer, must pass between application of the molten adhesive to the first substrate before an adhesive bond between the first substrate and a second substrate can form, wherein the adhesive bond is of sufficient strength to continue to the next step in the process without the adherends parting ways. Such effective set times mean that a conveyor type system for packaging is limited by the time it takes for the hot melt adhesive to build adhesion. In some embodiments, the hot melt adhesive compositions of the claimed adhesive have an effective set time of less than 5 seconds, and in some embodiments the effective set time is as short as 0.1 second. Such a rapid effective set time is, for industrial purposes, “instant”, and represents a significant advantage for industrial uses of hot melt adhesives. A rapid effective set time enables the use of the hot melt adhesive composition in industrial applications that previously did not employ hot melt adhesives because the long effective set time represented a bottleneck in productivity. Alternatively, the rapid effective set time of the hot melt adhesive compositions of the claimed adhesive enables a significant improvement in productivity where hot melt adhesives based on metallocene polymerized propylene copolymers are currently employed.

In some embodiments, the application of the hot melt adhesive compositions of the claimed adhesive is a packaging application. In some such embodiments, one or more packaging substrates are plain cardboard, corrugated cardboard, plain paper, or a combination thereof. In some embodiments, one or more packaging substrates have a surface coating of a wax or a polymer such as an acrylate polymer. In still other such embodiments, one or more packaging substrates has a metalized surface or is otherwise composed of one or more metal materials. It is an advantage of the hot melt adhesive compositions of the claimed adhesive that in various embodiments, the compositions provide adhesive bonding to all such substrates. That is, various hot melt adhesive compositions are suitably formulated to include various additional components such as any of those described above, to provide excellent adhesive bonding to an intended substrate at an intended use temperature and in an intended amount; and in each case, the adhesive composition retains the rapid effective set time of about 0.1 second to 5 seconds.

### Model Formulations

| Component | Wt. % | Wt. % | Wt. % |
|---|---|---|---|
| Ethylene/α-olefin | >30 | 30-70 | 45-65 |
| polymer | | | |
| Isotactic propylene | 35-55 | 40-50 | 35-45 |
| polymer or | | | |
| copolymer | | | |
| Tackifing agent | 0.1-15 | 0.1-12 | 0.1-10 |
| Nucleating agent | 0.01-10 | 0.05-5 | 0.1-3 |

### Experimental

### Introduction

The claimed adhesive has been developed as a response to recent shortages of Fischer-Tropsch waxes and water white tackifiers such as hydrogenated tackifiers and the continuing demand in the packaging industry for maintenance free, low-density and high performance water white adhesives that maintain bonds at both high temperature environments as well as at freezer temperatures to surfaces that are not easily bonded.

### Product Comparisons

The claimed adhesive was compared side by side to known commercial hot melt adhesives and well known industry standard hot melt adhesives. The products that were compared were EVA based adhesives, traditional Metallocene catalyzed ethylene-octene (Affinity) based adhesives, other standards and lastly a Metallocene catalyzed polypropylene based adhesive.

| | Amount |
|---|---|
| Component | Wt. % |
| Ethylene-octene copolymer | 52.4 |
| (Affinity GA-1875) | |
| Isotactic Polypropylene | 39.5 |
| (Licocene PP-6102) | |
| (Metallocene Polyethylene | 2.8 |
| wax) | |
| Licocene PE-4201 | |
| Anti-oxidant stabilizer | 0.5 |
| (Irganox 1010) | |
| Tackifier | 4.8 |
| (Sylvarex TP-2019) | |

| Measurement | Basis | result |
|---|---|---|
| Brookfield Viscosity (cP) @ | 1045 | 875 |
| 350° F. (176.66° C.) | | |
| Mettler Softening Point | 143° C. | 108° C. |
| IoPP heat stress resistance | 140° C. | 75° C. |
| Specific Gravity | 0.89 | 0.97 |
| Bonds (% Fiber Tear) | | |
| Inland Container stock | | |
| 70° F. (21.1° C.) | 100 | 100 |
| 35° F. (1.67° C.) | 100 | 50 |
| −25° F. (−31.67° C.) | 100 | 0 |
| Eucalyptus board stock | | |
| 70° F. (21.1° C.) | 100 | 100 |
| 35° F. (1.67° C.) | 100 | 60 |
| −25° F. (−31.67° C.) | 100 | 0 |

### Bond Testing

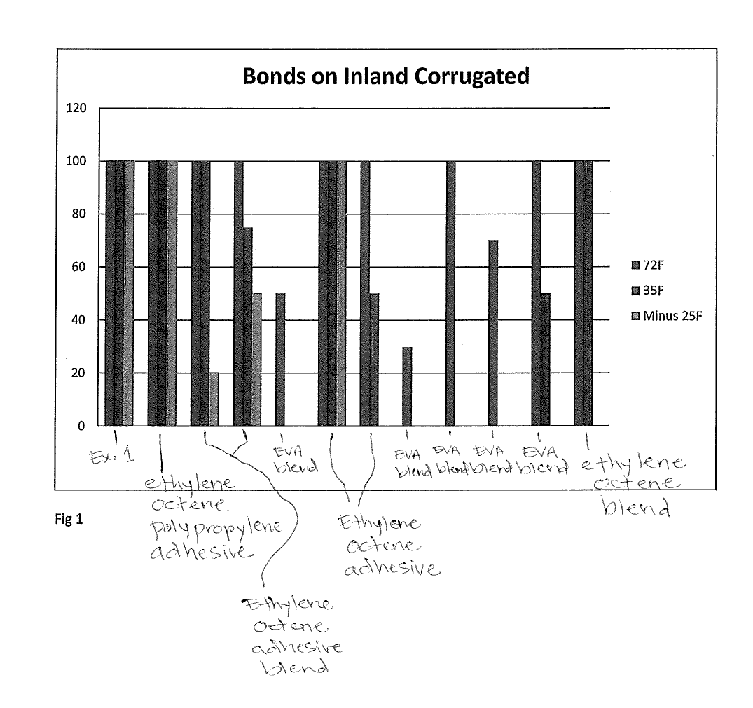

Bond testing was done on Inland Container 200 pound C flute virgin corrugated board stock with all adhesives being applied at 350° F. (176.66° C.). The bonds were conditioned for 24 hours at each test temperature before checking for percent (%) fiber tear when manually pulled apart at each test temperature (see FIG. 1).

### Density

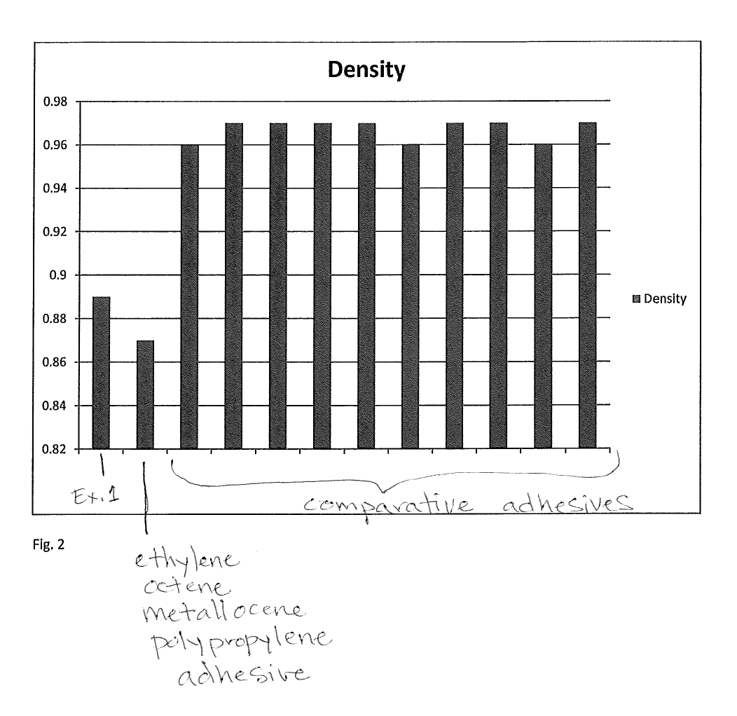

The density of each adhesive was calculated based on the percentage of each raw material in a given formulation and the specific gravity of the raw material. Therefore the reported values (see FIG. 2) are a calculated density as opposed to a measured product density. Low density materials (less than 0.9 grams per cubic centimeter) allow for more boxes to be glued per each gram of adhesive purchased (compared to high density 0.9 to 0.96 grams per cubic centimeter).

### Thermal Stability (Color and Viscosity)

The thermal stability of each product was tested by weighing 300 grams of each adhesive and placing it in a one pint metal can. Each adhesive was then placed in a forced air oven set at 350° F. (176.66° C.) for 100 hours. At the end of 100 hours the initial product viscosity (see FIG. 3 Brookfield Viscosity-spindle #27 @100 rpm @350° F. (176.66° C.)) was compared to the aged product viscosity and the initial molten Gardner color was compared to the aged Gardner color. The lower the Gardner color number (see FIG. 4) the lighter in color the product is (Gardner 1=water white).

### Heat Stress Resistance

The adhesives resistance to bond failure under elevated temperature conditions was measured using the Institute of Packaging Professionals (IoPP) suggested test procedure “Heat Stress Resistance of Hot Melt Adhesives” test method T-3006. The values reported (see FIG. 5) are the highest temperature that the adhesive is able to hold together the two substrates without failing.

FIGS. 1-2 show excellent bond strength and low density adhesive materials.

### CONCLUSIONS

The claimed adhesive is overall a better adhesive than any of the adhesives in this study.

The claimed adhesive is lighter color with better color stability than any of the products tested with the exception of an essentially equivalent Metallocene catalyzed polypropylene based adhesive.

The claimed adhesive is more viscosity stable than all products with the exception Metallocene catalyzed ethylene-octene (Affinity) based adhesive and a Metallocene catalyzed polypropylene based adhesive of which it is equivalent to.

The claimed adhesive has significantly higher heat resistance than all of the products.

The claimed adhesive has better bond performance than all the products except a Metallocene catalyzed polypropylene based adhesive and Metallocene catalyzed ethylene-octene (Affinity) based adhesives which it is comparable to.

The claimed adhesive has a significant advantage over all of these products in density with the exception of a Metallocene catalyzed polypropylene based adhesive so its mileage should be far superior then all the rest.

Given that the claimed adhesive is formulated from (1) materials that are abundantly (compared to Fischer-Tropsch waxes and water white tackifiers hydrogenated tackifiers) available and polymers made of inexpensive monomers, the claimed adhesive should be more price stable and be more resistant to availability issues than any of the other hot melt adhesive technologies over the long run with the exception of a generally equivalent metallocene catalyzed polypropylene based adhesive.

The claims may suitably comprise, consist of, or consist essentially of, or be substantially free of any of the disclosed or recited elements. The claimed adhesive illustratively disclosed herein can also be suitably practiced in the absence of any element which is not specifically disclosed herein. The various embodiments described above are provided by way of illustration only and should not be construed to limit the claims attached hereto. Various modifications and changes may be made without following the example embodiments and applications illustrated and described herein, and without departing from the true spirit and scope of the following claims.

Claimed is:

1. A hot-melt adhesive composition comprising:
an ethylene alpha-olefin copolymer, a crystalline isotactic polypropylene polymer or copolymer and less than about 15 weight percent of a tackifing resin; wherein the density of the hot-melt adhesive material is less than about 0.90 g-cm⁻³.

2. The adhesive of claim 1 wherein the adhesive comprises nucleating agent

3. The adhesive of claim 2 wherein the nucleating agent comprises a polyolefin wax.

4. The adhesive of claim 3 wherein the ethylene alpha olefin polymer is a random polymer and the polyolefin wax is a homopolymer of either ethylene or propylene having a molecular weight of about 1000 to about 20,000.

5. The adhesive of claim 2 wherein the nucleating agent comprises a polypropylene polymer wax having a density of about 0.94 to about 1.03 g-cm⁻³.

6. The adhesive of claim 2 wherein there is about 30-60 weight percent of the ethylene alpha olefin polymer and about 40-50 weight percent of the polypropylene and about 0.01-10 weight percent of nucleating agent and 0.1-10 wt % of a tackifing resin.

7. The adhesive of claim 1 wherein the density of the adhesive is less than 0.88 g-cm⁻³.

8. A hot-melt adhesive composition comprising:
an ethylene-octene copolymer having density of 0.86 to 0.89
g-cm⁻³, a molecular weight (Mw) of about 800 to 15,000 and about 15-45 mole % octene, a crystalline isotactic polypropylene polymer 0.87 g-cm⁻³ to 0.9 g-cm⁻³, less than about 15 weight percent of a tackifing resin and about 0.1 to 10 wt. % of a nucleating agent;
wherein the density of the hot-melt adhesive material is less than about 0.85 g-cm⁻³.

9. A hot-melt adhesive composition comprising:
About 45-65 wt. % of an ethylene-octene copolymer having density of 0.86 to 0.89 g-cm⁻³, a molecular weight (Mw) of about 800 to 15,000 and about 15-45 mole % octene, about 35-45 wt. % of a crystalline isotactic polypropylene polymer 0.87 g-cm⁻³ to 0.9 g-cm⁻³, less than about 15 weight percent of a tackifing resin and about 0.1 to 10 wt. % of a nucleating agent; wherein the density of the hot-melt adhesive material is less than about 0.85 g-cm⁻³.
